(19) United States
(12) Patent Application Publication
(10) Pub. No.: US 2024/0208100 A1
(43) Pub. Date: Jun. 27, 2024

(54) APPARATUS FOR CUTTING PACKAGES

(71) Applicant: MULTIVAC SEPP HAGGENMÜLLER SE & CO. KG, Wolfertschwenden (DE)

(72) Inventors: Markus WEILAND, Bad Grönenbach (DE); Dominik PATZ, Kempten (DE); Dorothea VÖLK, Markt Rettenbach (DE); Manuel WÖLFLE, Lauben (DE)

(73) Assignee: MULTIVAC SEPP HAGGENMÜLLER SE & CO. KG, Wolfertschwenden (DE)

(21) Appl. No.: 18/389,912

(22) Filed: Dec. 20, 2023

(30) Foreign Application Priority Data
Dec. 21, 2022 (DE) 102022134298.0

(51) Int. Cl. B26D 5/04; B26D 1/157; B26D 5/00

(52) U.S. Cl. CPC B26D 5/04; B26D 1/157; B26D 5/005

(57) ABSTRACT

An apparatus for cutting packages includes a first drive shaft for driving a first cutting blade and a second drive shaft, arranged parallel to the first drive shaft, for driving a second cutting blade, where the second cutting blade is mounted rotatably about a rotation axis. The apparatus also includes an adjusting device assigned to the second cutting blade and having a movable actuating element. The actuating element is adapted to adjust a position of the second cutting blade and/or a pressing force of the second cutting blade on the first cutting blade and the actuating element is mounted movably along a direction parallel to the rotation axis and at a distance from the rotation axis.

### CROSS-REFERENCE TO RELATED APPLICATIONS

This application claims foreign priority benefits under 35 U.S.C. § 119(a)-(d) to German patent application number 102022134298.0, filed Dec. 21, 2022, which is hereby incorporated herein by reference in its entirety.

### TECHNICAL FIELD

The present disclosure relates to an apparatus for cutting packages according to claim 1 and to a method for adjusting a pressing force of a second cutting blade on a first cutting blade and/or a position of the second cutting blade of an apparatus for cutting packages according to independent claim 12.

### BACKGROUND

Apparatuses for cutting packages are known from the prior art. The apparatuses usually comprise cutting blades arranged in pairs, which are arranged in such a way that they can cut a film of or for a package that is guided along them. For this purpose, the cutting blades are arranged adjacent to each other so that the cutting blades exert a pressing force on each other.

It is also known to arrange the cutting blades on different cutting shafts. For this purpose, it is also known to arrange a first cutting blade on a first cutting shaft and to arrange at least a second or a second and a third cutting blade on the second cutting shaft, wherein the two or three cutting blades interact in such a way that a film is cut. If the second and third cutting blades are arranged together on the second cutting shaft, it may be provided that the position of the second and third cutting blades can be adjusted with respect to each other, so that a strip cut of the package is also possible.

During operation of known apparatuses, it may be necessary to adjust the relative arrangement of the cutting blades, for example to adjust the strip width or to regulate the pressing force of the cutting blades on each other or to remove a cutting shaft with the cutting blades arranged thereon from the apparatus for the purpose of a format change. However, this changeover work has so far been associated with considerable design effort and also requires an operator to intervene in the apparatus, which poses a risk of injury due to the sharp cutting blades.

### SUMMARY

Based on the known prior art, the technical object to be solved is therefore to specify an apparatus for cutting packages, with which the adjustment of the pressing force and/or the replacement of cutting blades can be ensured in a structurally simple and at the same time safe manner.

According to the disclosure, this object is solved by the apparatus for cutting packages and the method disclosed herein for adjusting a pressing force of a second cutting blade on a first cutting blade and/or a position of the second cutting blade of an apparatus for cutting packages. Advantageous further embodiments are also disclosed herein.

The apparatus according to the disclosure for cutting packages comprises a first drive shaft for driving a first cutting blade and a second drive shaft arranged parallel to the first drive shaft for driving a second cutting blade, wherein the second cutting blade is mounted rotatably about a rotation axis and wherein the apparatus comprises an adjusting device assigned to the second cutting blade with a movable actuating element, wherein the actuating element is adapted to adjust a position of the second cutting blade and/or a pressing force of the second cutting blade on the first cutting blade, and the actuating element is mounted movably along a direction parallel to the rotation axis and at a distance from the rotation axis.

The direction parallel to the rotation axis and at a distance from the rotation axis is to be understood as the direction along which the actuating element is movably mounted and not a direction which is merely parallel to this direction. According to the disclosure, the movable actuating element is thus not arranged to be movable coaxially to the rotation axis, but is positioned offset to the rotation axis and arranged to be movable along a direction which is offset but parallel to the rotation axis. In particular, it may be provided that the adjusting device or at least the actuating element is arranged outside the cutting blade and an imaginary cylinder, the cross-section of which forms the cutting blade.

This makes any suspension or hub of the cutting blade, around which the cutting blade itself is rotatably mounted, more easily accessible, which in particular facilitates format changes and/or blade changes. At the same time, the spaced arrangement makes it possible to advantageously adjust the guide ratio when moving the second cutting blade, which leads to a more precise determination or adjustment of the pressing force.

It may be provided that the actuating element is a pneumatically operated actuating element, for example a piston of a pneumatic cylinder or a membrane. This allows the pressing force to be set and the second cutting blade to be moved in a technically simple and reliable manner.

The apparatus may comprise a third cutting blade which can be driven by the second drive shaft, wherein the adjusting device is adapted to adjust a distance between the second cutting blade and the third cutting blade. This can be used to realize settings for the cutting width when cutting packages or parts of packages.

In a further development of this embodiment, it is provided that a first resetting element is assigned to the second cutting blade and a second resetting element is assigned to the third cutting blade, wherein the first resetting element and the second resetting element can effect a movement of the actuating element into a synchronous movement of the second cutting blade and the third cutting blade.

The resetting element can, for example, be designed as a spring or comprise such a spring, which can be arranged between the actuating element and, for example, a fixed part of the holder and pretension the respective cutting blade in the direction of the actuating element. The movement of the actuating element can thus be divided evenly between the second and third cutting blades due to the effect against the spring force.

It is also possible for the second drive shaft, the second cutting blade and the adjusting device to be arranged on a common frame. This makes it easy to replace the cutting blades. In particular, there is no need to remove individual cutting blades separately, which reduces the risk of injury to the operator.

The adjusting device can be adapted to adjust the position of the second cutting blade between a working position, in which the second cutting blade is arranged together with the first cutting blade for cutting packages, and a resting position, in which the second cutting blade is arranged at a distance from the first cutting blade. This simplifies the changeover of the apparatus and, in particular, further reduces the risk of injury to an operator.

The adjusting device can be arranged on a suspension of the second cutting blade or the adjusting device can be adapted to adjust a position of a suspension of the second cutting blade. The suspension of the second cutting blade can, for example, form a connecting element to a fixed frame of the apparatus or comprise the same. If the connecting element itself is movably arranged, the position of the suspension can also be changed with this embodiment. This can be used advantageously, for example, to realize larger adjustment paths of the cutting blade. This can be used advantageously to a changeover of the apparatus to other cutting blades, for example, or to replace cutting blades. If the adjusting device is arranged on the suspension itself, this provides a reliable reference for adjusting the position and/or other force of the second cutting blade, wherein a variable coarse adjustment of the position of the cutting blade is still possible.

It may be provided that the suspension is arranged on a guide parallel to the second drive shaft. The guide can be designed as a rail, for example, along which the suspension can be movably mounted. A detachable connection to the guide (for example via screws) can be provided to fix the suspension. If the guide is detachably connected to the apparatus, this allows cutting blades to be easily replaced.

The apparatus can comprise a force sensor that can measure a contact pressure between the second cutting blade and the first cutting blade. This can be used to reliably adjust the contact pressure between the first and second cutting blades.

The apparatus can comprise a control unit for controlling the adjusting device. In this way, automatic adjustment of the pressing force and/or position of the second cutting blade is realized. In this way, errors that can be associated with manual operation can be avoided. Alternatively, a manually operable adjusting device can be provided for manual adjustment of the adjusting device or the adjusting element. This reduces the complexity of the apparatus.

The control unit can be adapted to control the adjusting device depending on the pressing force. In particular, the force sensor already mentioned in one of the embodiments described above can be used. Through the interaction of the control unit and force sensor, a control circuit can optionally be established, which realizes an adjustment of the actuating element depending on the pressing force, for example until a desired pressing force is reached. This allows changes in the position of the second cutting blade, for example due to wear, to be taken into account. Alternatively, or additionally, the wear on the cutting blades can be reduced by adjusting the pressing force by precisely setting the pressing force to a desired value, preferably with little wear.

The method according to the disclosure for adjusting a pressing force of a second cutting blade on a first cutting blade and/or a position of the second cutting blade of an apparatus for cutting packages, wherein the apparatus comprises a first drive shaft for driving the first cutting blade and a second drive shaft arranged parallel to the first drive shaft for driving the second cutting blade, wherein the second cutting blade is mounted rotatably about a rotation axis and wherein the apparatus comprises an adjusting device assigned to the second cutting blade with a movable actuating element, wherein the actuating element is adapted for adjusting a position of the second cutting blade and/or a pressing force of the second cutting blade on the first cutting blade and the actuating element is mounted movably along a direction parallel to the rotation axis and at a distance from the rotation axis, comprises changing the position of the actuating element for adjusting the pressing force and/or the position of the second cutting blade.

With this method, and improved adjustment of the pressing force is realized.

It may be provided that the apparatus comprises a control unit and a force sensor, wherein the control unit controls the adjusting device as a function of the pressing force between the second cutting blade and the first cutting blade measured by the force sensor in order to adjust the pressing force and/or the position of the second cutting blade. In this way, an automatic and reliable adjustment of the pressing force and/or the position of the second cutting blade can be realized.

The method may comprise adjusting the position of the second cutting blade between a working position, in which the second cutting blade is arranged together with the first cutting blade for cutting packages, and a resting position, in which the second cutting blade is spaced apart from the first cutting blade, by means of the adjusting device. In the resting position, the cutting blade can be removed from a suspension, for example. This simplifies the changeover of the apparatus.

The apparatus may comprise a third cutting blade driven by the second drive shaft, wherein the method comprises adjusting a distance between the second cutting blade and the third cutting blade by means of the adjusting device. In this way, the setting of cutting widths can also be advantageously carried out.

All embodiments described herein can be combined with one another, so that the apparatus and/or the method can comprise only individual or several or all of the features described.

### BRIEF DESCRIPTION OF THE DRAWINGS

FIG. 1 shows a schematic representation of an apparatus for cutting packages to size,

FIG. 2 shows a schematic view of a cutting blade arrangement according to one embodiment,

FIG. 3 shows an embodiment of a cutting blade with an assigned adjusting device,

FIG. 4a and b show different embodiments of an adjusting device,

FIG. 5a and b show different embodiments of a cutting blade arrangement with two cutting blades.

### DETAILED DESCRIPTION

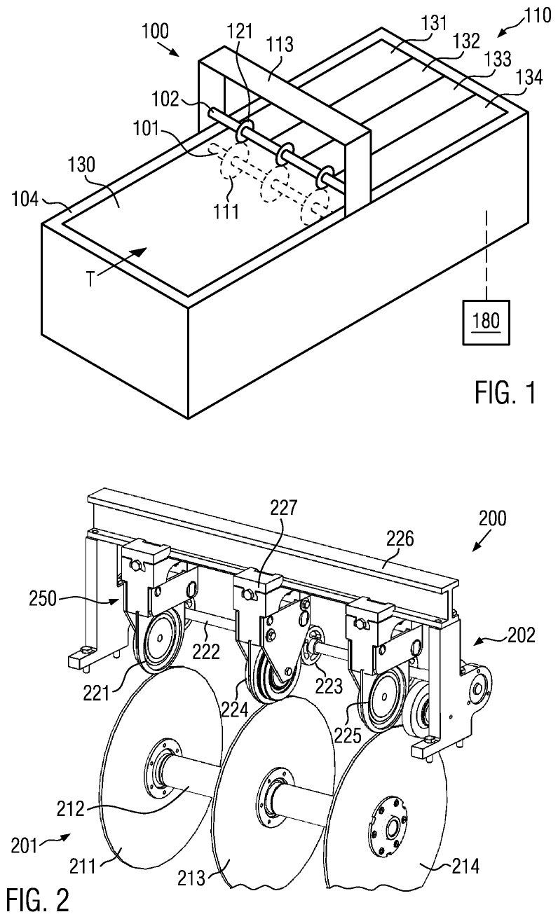

FIG. 1 shows a schematic view of an apparatus 110 for cutting packages 130. The term package 130 is to be understood here generally and may comprise, for example, the cutting of interconnected, preformed packaging troughs. According to the disclosure, however, this should also be understood to mean the cutting of a film web from which packages are later produced.

The apparatus 110 comprises a transport device 104, which transports the packages 130 to be cut along a transport device T. The transport device 104 can, for example, be adapted as a single-row or multi-row conveyor belt which can transport packages 130. However, the disclosure is not limited in this respect.

The apparatus 110 is preferably further assigned a control unit 180, which can be designed, for example, as a computer and can control at least some of the functions of the apparatus 110 and in particular of the cutting blades or cutting blade arrangement 100 described below. In that regard, as one skilled in the art would understand, the control unit 180, as well an any other unit, machine, apparatus, element, sensor, device, component, system, subsystem, arrangement, or the like described herein may individually, collectively, or in any combination comprise appropriate circuitry, such as one or more appropriately programmed processors (e.g. one or more microprocessors including central processing units (CPU)) and associated memory, which may include stored operating system software and/or application software executable by the processor(s) for controlling operation thereof and/or for performing the particular algorithms represented by the various functions and/or operations described herein, including interaction and/or cooperation between any such controller, unit, machine, apparatus, element, sensor, device, component, system, subsystem, arrangement, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

Furthermore, the apparatus 110 comprises a cutting blade arrangement 100. The cutting blade arrangement 100 may comprise a frame 113 which is detachably connected (for example via screw connections) to the transport device 104 or another part of the apparatus 110.

The cutting blade arrangement 100 further comprises a first drive shaft 101, which is connected to a first cutting blade 111. The first drive shaft 101 is rotatably mounted and is operatively connected to the cutting blade 111 in such a way that a rotation of the first drive shaft 101 can be translated into a rotation of the first cutting blade 111. For this purpose, the first cutting blade 111 can be arranged directly on the first drive shaft 101 or can be rotatably mounted about an axis that runs parallel to the first drive shaft 101. In the latter case, a transmission in the form of two or more meshing gears can be provided, which translates the rotation of the first drive shaft 101 into a rotation of the first cutting blade 111.

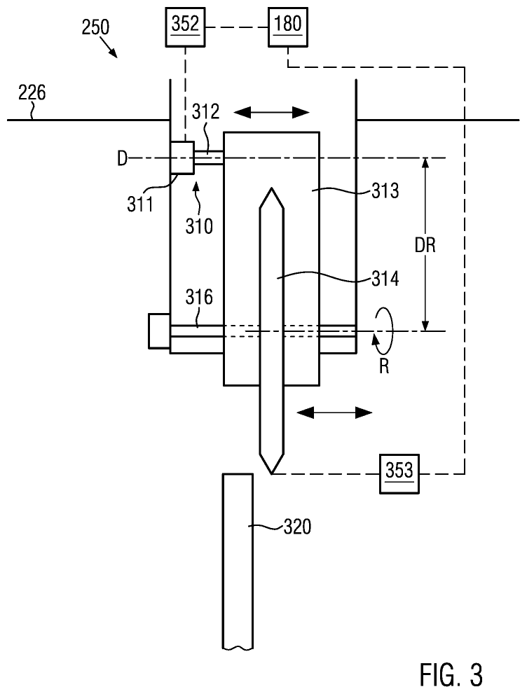

Furthermore, the cutting blade arrangement 100 comprises a second drive shaft 102 which is operatively connected to at least one second cutting blade 121 in order to set the second cutting blade 121 in rotation. As will be described with reference to FIG. 2, it is preferably provided that the second cutting blade 121 is not arranged on the second drive shaft 102, but is rotatably mounted on an axis of rotation or rotation axis extending parallel thereto. By rotating the second drive shaft 102, the second cutting blade 121 can be set in rotation, for example by means of suitable meshing gears.

The drive shafts 101 and 102 preferably extend or run parallel to each other. In particular, however, the first cutting blade 111 and the second cutting blade 121 are arranged relative to each other in such a way that a part of the package 130 to be cut can be positioned between them and the first cutting blade 111 and the second cutting blade 121 can cooperate in such a way that the package is separated by the first cutting blade 111 and the second cutting blade 121.

In the embodiment shown in FIG. 1, three first cutting blades 111 and corresponding three second cutting blades 121 are provided, so that the package or film web 130 is divided into four packaging strips 131-134 after passing through the cutting blade arrangement 100. This is not mandatory and any other number of first cutting blades 111 and second cutting blades 121 can also be provided. Furthermore, as will be described in subsequent embodiments, a pair of second cutting blades 121 may be assigned to each first cutting blade 111 in order to realize a strip cut of the package 130.

For the purposes of the disclosure, the first cutting blade 111 and the second cutting blade 121 need not both have a sharp cutting edge which can cause the package to be separated or the package 130 to be cut. It may also be provided that the first cutting blade 111 is designed as a counter-cutting blade and does not itself comprise a sharp cutting edge, and that the second cutting blade 121 comprises a sharp cutting edge. An alternative embodiment is also conceivable, wherein the first cutting blade 111 comprises a sharp cutting edge and the second cutting blade 121 is designed as a counter-cutting blade without a sharp cutting edge. Alternatively, the first cutting blade 111 and the second cutting blade 121 may also have a sharp cutting edge.

FIG. 2 shows a more detailed view of a cutting blade arrangement 200 as shown in respective FIG. 1.

The cutting blade arrangement 200 may comprise a frame 202 for receiving the second drive shaft 222 and the second cutting blades 221, 224 and 225. The second cutting blade or blades may each be connected to the second drive shaft 222 via suitable gears (shown schematically here as gear 223) so that a driving force of the second drive shaft 222 can be transmitted to the respective cutting blades 221, 224 and 225.

The respective second cutting blades 221, 224 and 225 may be rotatably attached to cutting blade elements 250. The cutting blade elements 250 may further be arranged on a guide 226 via suitable connecting elements 227, such as clamps, or may be fixedly connected to the frame 202.

The cutting blade arrangement 200 also comprises the first cutting blade component 201 shown here as 201 with the first drive shaft 212 and the associated first cutting blades 211, 213 and 214, which may or may not be connected to the frame 202. If the first cutting blade component 201 is connected to the frame 202 (not shown here), the frame 202 may also extend below the transport device 104 (see FIG. 1) to provide a connection for the first drive shaft 212. Alternatively, the first cutting blade component 201 may also be rotatably mounted within the transport device 104 (see FIG. 1) and the frame 202 may only be provided to receive the second cutting blades 221, 224, 225.

The first drive shaft and the second drive shaft can be driven via drives not shown here, such as a servomotor or an actuator, wherein each drive shaft can be assigned exactly one separate drive or the first drive shaft and the second drive shaft can be driven via a common drive.

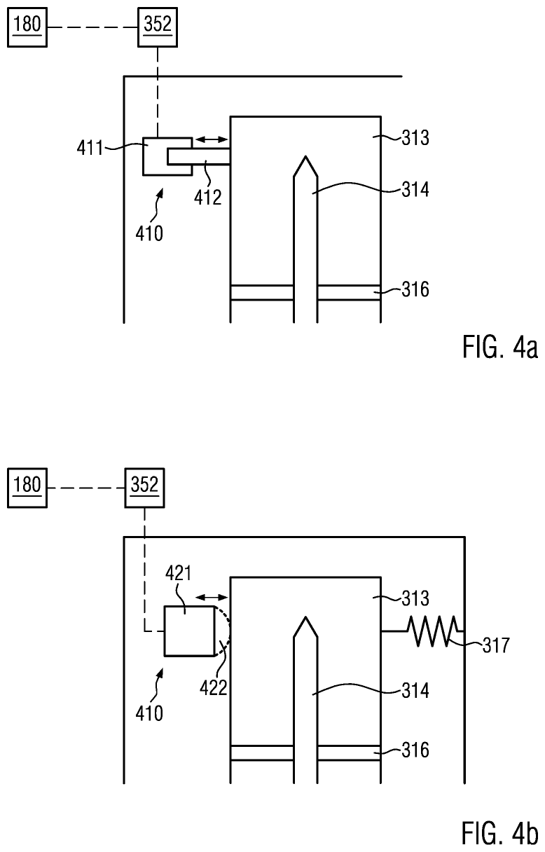

FIG. 3 shows an embodiment according to the disclosure by means of a single second cutting blade 314, which is mounted in the cutting blade unit 250 in FIG. 3 as an example. Also shown schematically in FIG. 3 is the guide 226, to which the cutting blade unit 250 can be attached, for example via clamping elements. It may be provided that the cutting blade unit 250 is mounted movably relative to the guide 226 as a whole, so that it can be moved along the guide (to the left or right in the embodiment shown here). For this purpose, for example, the clamping element 227 (FIG. 2) can be released and the cutting blade unit 250 can be moved and then the clamping element 227 can be reattached.

In the embodiment shown in FIG. 3, the second cutting blade 314 is mounted for rotation about a rotation axis R, for example along a hub 316 extending through the second cutting blade 314. The rotation axis R extends through the center of the second cutting blade 314, which is preferably substantially circular in shape. The second cutting blade 314 can be mounted in a suspension 313, which is movably arranged in the cutting blade unit 250 (in particular movably along the hub 316). In the embodiment shown in FIG. 3, the second cutting blade 314 is arranged adjacent to the first cutting blade 320, so that a package or film of a package not shown here can be cut by interaction of the first cutting blade 320 and the second cutting blade 314.

According to the disclosure, the arrangement shown here further comprises an adjusting device 310, which is preferably but not necessarily arranged in the cutting blade unit 250. The adjusting device 310 comprises an actuating element 312 mounted movably along the direction D (see double arrow), which can, for example, be connected to a counter element 311 fixedly arranged in the cutting blade unit 250, so that the actuating element 312 is mounted movably along the direction D in order to move at least the second cutting blade 314, optionally also the suspension 313 of the second cutting blade, along the double arrow direction shown, so that the second cutting blade 314 can be moved along the hub 316 along the double arrow direction shown. Thus, according to the disclosure, both the pressing force of the second cutting blade 314 on the first cutting blade 320 and the relative position of the second cutting blade 314 to the first cutting blade 320 can be adjusted.

According to the disclosure, it is provided that the adjusting device 310 and in particular the movable actuating element 312 is movable along a direction of movement D which, although parallel to the rotation axis R, is at a distance therefrom. The distance between the direction of movement D and the rotation axis R is basically arbitrary. Preferably, however, this distance is greater than the radius of the second cutting blade 314, so that the adjusting device 310 and in particular the actuating element 312 engages at a position of the suspension 313 that does not overlap with the second cutting blade 314. In particular, the movable actuating element 312 can be movably mounted along a direction D which lies outside an imaginary cylinder whose cross-section is the second cutting blade 314. In this case, the movable actuating element 312 is preferably located on the side of the second cutting blade 314 opposite the first cutting blade 320 as viewed from the rotation axis R.

In the embodiment shown here, the adjusting device 310 is adapted as a pneumatic adjusting device and/or the actuating element 312 is adapted as a pneumatically actuated actuating element. This is to be understood in such a way that the position of the actuating element can be changed along the direction D by feeding or discharging air or compressed air.

It may be provided that a compressed air supply 352 (such as a compressor) is connected to the adjusting device 310 for the purpose of supplying or discharging air, in particular compressed air. If more than one cutting blade 314 or more than one cutting blade unit 250 is provided (see also, for example, the description of FIGS. 1 and 2), it may be provided that a common compressed air supply 352 is provided for all second cutting blades, wherein all second cutting blades may be operatively connected to the compressed air supply 352 via a common main compressed air line and respective distribution lines feeding to the individual adjusting devices.

While manual control of the compressed air supply and thus of the pneumatically actuatable actuating element 312 is possible in principle, it may also be provided that the compressed air supply is connected to the control unit 180 for the purpose of exchanging control data. The control unit 180 can control the movement of the movable actuating element 312 by controlling the compressed air supply 352 in order to adjust the position of the second cutting blade 314 relative to the first cutting blade 320 or the pressing force of the second cutting blade 314 on the first cutting blade 320.

For this purpose, it may be provided that the apparatus comprises a force sensor 353. This force sensor is preferably arranged and configured to measure a contact pressing force between the second cutting blade 314 and the first cutting blade 320. The measured pressing force can then be transmitted from the force sensor 353 to the control unit 180, which can then control the compressed air supply 352 based on the measured pressing force in order to set the pressing force between the second cutting blade 314 and the first cutting blade 320 to a necessary or desired value, for example. To this end, the compressed air supply 352 is actuated to control the position or movement of the actuating element 312 along the direction D, thereby changing the position of the second cutting blade 314.

If the position of the second cutting blade is only changed to the extent that there is still physical contact between the first cutting blade 320 and the second cutting blade 314, this changes the pressing force between the first cutting blade 320 and the second cutting blade 314.

Advantageously, however, the adjusting device 310 can also be used to move the second cutting blade 314 from a working position, in which it can cooperate with the first cutting blade to cut a package, to a resting position, in which the second cutting blade 314 is spaced apart from the first cutting blade 320. Once the second cutting blade has been moved to this position, a release of the second cutting blade or all second cutting blades from the apparatus for cutting packages can be effected, for example, by lifting the frame 202 (see FIG. 2).

Alternatively, the second cutting blade may be released from the suspension 313, for example by removing the hub 316. For example, the second cutting blade may be mounted in the suspension together with one or more retaining rings arranged coaxially with the cutting blade and extending partially along the hub 316. After removal of the second cutting blade and the retaining ring or rings, the cutting blade can be detached from the retaining rings and replaced, for example.

In FIG. 3, the adjusting device is arranged such that the counter element 311 is connected to the cutting blade unit 250 fixed to the guide 226 and the movable actuating element 312 moves the suspension 313 of the second cutting blade 314 relative to the cutting blade unit 250. Alternatively, it may also be provided that the actuating element 312 is connected to the stationary cutting unit 250 and the counter element 311 of the adjusting device is connected to the suspension 313, so that the stationary part is displaced by actuating the actuating element 312.

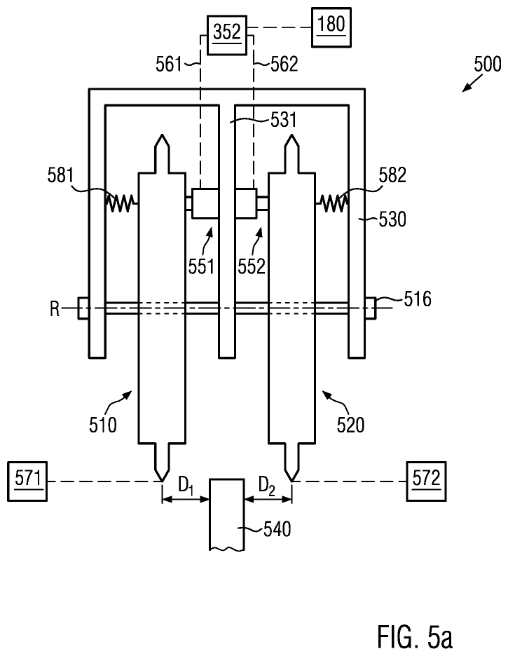

FIG. 4a shows an embodiment of an adjusting device 410 of the general embodiment of FIG. 3 as a pneumatic cylinder.

In the illustration shown here, only the suspension 313 with the second cutting blade 314 arranged therein, which is rotatably mounted about the hub 316, is shown. The adjusting device 410 comprises a pneumatic cylinder, the piston 412 of which is designed as an actuating element. The cylinder 411 is the counter element of the adjusting device and can be supplied with compressed air via the compressed air supply 352 (optionally controlled by the control unit 180), so that the actuating element 412 can be moved along the double-arrow direction shown in order to change the position or contact pressure of the second cutting blade 314 on the first cutting blade (not shown here) in the same way as in FIG. 3.

The piston 412 can be firmly connected to the suspension 313, for example via one or more screw connections.

FIG. 4b shows an alternative embodiment to FIG. 4a. Here, too, only the suspension 313 and the second cutting blade 314, which is rotatably mounted about the hub 316, are shown. In the embodiment shown here, the adjusting device 420 comprises a compressed air receptacle 421, into which compressed air can be introduced via the compressed air supply 352 or withdrawn from it. As described in the previous embodiments, this can be optimally controlled by the control unit 180.

In this embodiment, the adjusting device 420 further comprises a membrane 422 which is movable by compressed air and which is operatively connected to the suspension 313 or to the cutting blade 314, so that the position of the suspension or of the second cutting blade 314 can be changed depending on the pressure prevailing in the compressed air receptacle 421 or the pressure difference between the interior of the compressed air receptacle 421 and the external pressure. If the internal pressure in the compressed air receptacle 421 is reduced, the movable membrane 422 is pulled in the direction of the compressed air receptacle 421. As a result, the second cutting blade 314 or the suspension 313 and the second cutting blade arranged therein are also moved in the direction of the compressed air receptacle 421, as a result of which, for example, the second cutting blade can be moved closer to the first cutting blade or the pressing force on the first cutting blade can be increased.

If the internal pressure in the compressed air intake is increased, the membrane is moved in the opposite direction and the suspension 313 or the second cutting blade 314 is moved in the respective direction, so that the pressing force on the first cutting blade decreases or the distance between the first cutting blade and the second cutting blade is increased.

It is understood that increasing and decreasing the pressing force or the distance to the first cutting blade depends on the positioning of the first cutting blade. What has been described so far applies to an arrangement of the first cutting blade in FIG. 4b to the left of the second cutting blade. The reverse applies to an arrangement of the first cutting blade to the right of the second cutting blade 314.

For example, the membrane 422 may be bonded to the suspension 313 of the second cutting blade 314. Other embodiments for connecting the membrane 422 to the suspension 313 are also conceivable. For example, the membrane may be bolted to the suspension, wherein one or more sealing elements may be provided to seal the pressure space enclosed between the compressed air receptacle 421 and the movable membrane 422. Other embodiments are also conceivable, provided that a movement of the membrane 422 can be converted into a movement of the suspension 313 for moving the cutting blade 314.

FIG. 4b also shows a resetting element 317. This resetting element 317 can, for example, be designed as a spring or as a pair of magnets that repel each other. The resetting element can preferably be designed in such a way that it biases the suspension 313 in the direction of the adjusting device 410. This has the effect that, when the internal pressure in the pressure receptacle 421 is reduced and the membrane 422 moves in the direction of the compressed air receptacle 421, the suspension 313 is also pressed in this direction by the resetting force of the resetting element 317 acting from the opposite side. In such an embodiment, a fixed connection between the movable membrane 422 and the suspension 413 may be omitted, but may optionally still be provided.

A respective resetting element can also be provided in the embodiment described in FIG. 4a. Alternatively, in FIG. 4a, the piston of the pneumatic cylinder can also be designed as a component of the suspension 313 of the second cutting blade 314 or be connected to the latter, for example via screw connections or other fixed connections.

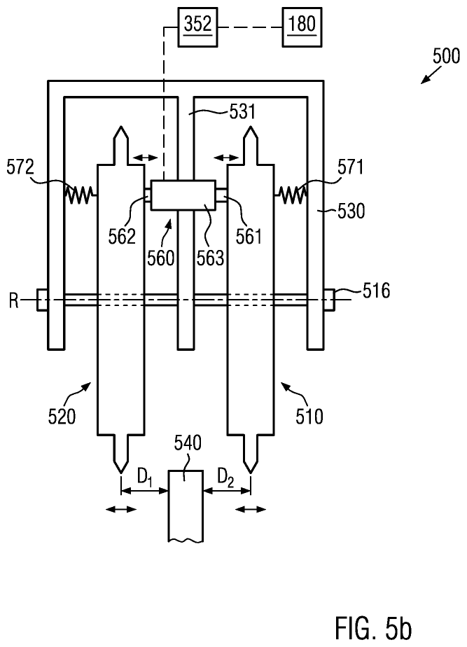

FIG. 5a shows a further embodiment of the disclosure, wherein in the cutting blade unit 500 shown here, two second cutting blades 510 and 520 are rotatably mounted about a common rotation axis R, which is formed, for example, by the hub 516. Instead of a continuous hub 516, a separate hub may also be provided for each second cutting blade 510 and 520. In this embodiment, the second cutting blades may also be assigned suspensions as described in the previous embodiments, but these are not described in further detail here.

The second cutting blades 510 and 520 may cooperate with a first cutting blade 540 to realize a strip cut of a film, wherein the strip cut comprises severing the film such that a strip between the first second cutting blade 510 and the second second cutting blade 520 is severed from the package in cooperation with the first cutting blade 540.

The cutting blade unit 500 preferably comprises a frame 530, which supports the two second cutting blades 510 and 520 or their suspensions. The frame 530 may comprise a center element 531, but need not do so. In the embodiment shown here, each of the second cutting blades 510 and 520 is assigned a separate adjusting device 551 and 552, respectively, which can optionally be attached to the center element 531. These adjusting devices 551 and 552 may be designed in respective embodiments of each of the preceding embodiments. In particular, each of the adjusting devices 551 and 552 may be connected to a compressed air supply 352 via a suitable compressed air supply line 561 and 562, respectively, in accordance with the preceding embodiments. The compressed air supply 352 can in turn be connected to the control unit 180, so that the control unit can control the position of the first and second cutting blades 510 and the position of the second cutting blade 520, for example, based on a contact pressure measured by a force sensor.

For this purpose, it may be provided that a separate force sensor 571 or 572 is assigned to each of the second cutting blades, which can measure the pressing force of the respective second cutting blade on the first cutting blade 540. The control unit 180 can then obtain the measured pressing force from each of the force sensors 571 and 572 (for example via a suitable data connection) and, based on the measured pressing force, can then control the adjusting device 551 or 552 in order to control the pressing force and/or the position of the first second cutting blade 510 or the second second cutting blade 520.

Analogous to the embodiments described so far, resetting elements 581 and 582 can be assigned to the first second cutting blade 510 and the second second cutting blade 520, which preferably effect a resetting force of the respective second cutting blade in the direction of the respective adjusting device. This ensures reliable adjustment of the position or pressing force of the second cutting blades 510 and 520.

By providing separate adjusting devices 551 and 552, it is possible to adjust the distance D1 of the first second cutting blade 510 to the first cutting blade 540 and the distance D2 of the second second cutting blade 520 to the first cutting blade 540 independently of one another. The same applies to the pressing force exerted by the respective second cutting blades on the first cutting blade 540. This can be advantageously used, for example, to take account of uneven wear of the second second cutting blades 510 and 520.

FIG. 5b shows an alternative embodiment to FIG. 5a, wherein the first second cutting blade 510 and the second second cutting blade 520 are assigned a common adjusting device 560 comprising two actuating elements 561 and 562, wherein one of these actuating elements 561 and 562 is connected to each of the second cutting blades 510 and 520. Preferably, the adjusting device 560 comprises exactly one compressed air receiving area 563 to which compressed air can be applied. This can be, for example, the stationary part of a pneumatic cylinder or, as already described with reference to FIG. 4b, for example, the compressed air receiving area.

The movable actuating elements 561 and 562 can be designed respectively as cylinder pistons of a planatic cylinder or as movable membranes.

With this design, the number of compressed air lines can be reduced.

Furthermore, analogous to the embodiments described so far, a resetting element can also be assigned to each of the second cutting blades 510 and 520 in this embodiment. The resetting elements 571 and 572 effect a restoring force or pretensioning force of the respective second cutting blade 510 and 520 in the direction of the adjusting device 560. This can be used particularly advantageously in this embodiment to effect a synchronous movement of the cutting blades 510 and 520, so that the distances D1 and D2 to the first cutting blade 540 or the respective pressing forces for both cutting blades are as equal as possible.

What is claimed is:

1. An apparatus for cutting packages, the apparatus comprising:
a first drive shaft for driving a first cutting blade;
a second drive shaft, arranged parallel to the first drive shaft, for driving a second cutting blade, wherein the second cutting blade is mounted rotatably about a rotation axis; and
an adjusting device assigned to the second cutting blade and having a movable actuating element, wherein the actuating element is adapted to adjust a position of the second cutting blade and/or a pressing force of the second cutting blade on the first cutting blade and wherein the actuating element is movably mounted along a direction parallel to the rotation axis and spaced from the rotation axis.

2. The apparatus according to claim 1, wherein the actuating element is a pneumatically operable actuating element, for example a piston of a pneumatic cylinder or a membrane.

3. The apparatus according to claim 1, wherein the apparatus comprises a third cutting blade which can be driven by the second drive shaft wherein the adjusting device is adapted to adjust a distance between the second cutting blade and the third cutting blade.

4. The apparatus according to claim 3, wherein a first resetting element is assigned to the second cutting blade and a second resetting element is assigned to the third cutting blade wherein the first resetting element and the second resetting element can convert a movement of the actuating element into a synchronous movement of the second cutting blade and the third cutting blade.

5. The apparatus according to claim 1, wherein the second drive shaft the second cutting blade and the adjusting device are arranged on a common frame.

6. The apparatus according to claim 1, wherein the adjusting device is adapted to adjust the position of the second cutting blade between a working position, in which the second cutting blade is arranged together with the first cutting blade for cutting packages, and a resting position in which the second cutting blade is arranged at a distance from the first cutting blade.

7. The apparatus according to claim 6, wherein the adjusting device is arranged on a suspension of the second cutting blade or wherein the adjusting device is adapted to adjust a position of a suspension of the second cutting blade.

8. The apparatus according to claim 7, wherein the suspension is arranged on a guide parallel to the second drive shaft.

9. The apparatus according to claim 1, wherein the apparatus comprises a force sensor capable of measuring a pressing force between the second cutting blade and the first cutting blade.

10. The apparatus according to claim 1, wherein the apparatus comprises a control unit for controlling the adjusting device.

11. The apparatus according to claim 10, wherein the control unit is adapted to control the adjusting device depending on the pressing force.

12. A method for adjusting a pressing force of a second cutting blade on a first cutting blade and/or a position of the second cutting blade of an apparatus for cutting packages, the apparatus comprising a first drive shaft for driving the first cutting blade and a second drive shaft, arranged parallel to the first drive shaft, for driving the second cutting blade, wherein the second cutting blade is mounted rotatably about a rotation axis, the apparatus further comprising an adjusting device assigned to the second cutting blade with a movable actuating element wherein the actuating element is adapted to adjust a position of the second cutting blade and/or a pressing force of the second cutting blade on the first cutting blade and the actuating element is movably mounted along a direction parallel to the rotation axis and spaced from the rotation axis, the method comprising:
changing the position of the actuating element for adjusting the pressing force and/or the position of the second cutting blade.

13. The method according to claim 12, wherein the apparatus further comprises a control unit and a force sensor, the method further comprising:
measuring, by the force sensor, a pressing force between the second cutting blade and the first cutting blade; and
controlling, by the control unit, adjustment by the adjusting device of the pressing force and/or the position of the second cutting blade depending on the pressing force between the second cutting blade and the first cutting blade measured with the force sensor.

14. The method according to claim 12, further comprising adjusting the position of the second cutting blade between a working position, in which the second cutting blade is arranged together with the first cutting blade for cutting packages, and a resting position in which the second cutting blade is spaced apart from the first cutting blade by the adjusting device.

15. The method according to claim 12, wherein the apparatus comprises a third cutting blade driven by the second drive shaft, the method further comprising adjusting a distance between the second cutting blade and the third cutting blade by the adjusting device.
